(19) United States
(12) Patent Application Publication
(10) Pub. No.: US 2023/0230021 A1
(43) Pub. Date: Jul. 20, 2023

(54) SYSTEM AND METHOD FOR AUTOMATICALLY OBTAINING AND PROCESSING LOGISTICS AND TRANSPORTATION REQUESTS

(71) Applicant: Hubtek, Miami, FL (US)

(72) Inventor: Ricardo Gonzalez Betancur, Miami, FL (US)

(21) Appl. No.: 17/580,102

(22) Filed: Jan. 20, 2022

(51) Int. Cl. G06Q 10/08; G06F 40/40; G06V 30/412; G06V 30/19

(52) U.S. Cl. CPC G06Q 10/08345; G06F 40/40; G06V 30/412; G06V 30/191

(57) ABSTRACT

The present disclosure relates to a system and method for automatically obtaining and processing logistics requests is provided. Embodiments include automatically identifying, using a processor, a logistics request from a logistics request receiver. In response to automatically identifying, embodiments include extracting information from the logistics request and providing the extracted information to an automated quoting validator. Embodiments also include automatically generating at least one quote for the request at the automated quoting validator based upon, at least in part, one or more user defined parameters.

### FIELD OF THE INVENTION

The present disclosure relates to technology for use with shipping and logistics operations. More specifically, embodiments included herein are directed towards automatically obtaining and processing logistics and transportation requests.

### DISCUSSION OF THE RELATED ART

The transportation and logistics industry faces numerous headwinds as companies face decreasing margins and higher employment costs. Existing approaches for handling various shipping requests are handled manually and often overwhelm the workers tasked with responding to these requests and providing a rate quote for each request. These tasks tend to be tedious and repetitive for these workers.

### SUMMARY OF DISCLOSURE

In one or more embodiments of the present disclosure, a computer-implemented method for automatically obtaining and processing logistics requests is provided. The method may include automatically identifying, using a processor, a logistics request from a logistics request receiver. In response to automatically identifying, the method may also include extracting information from the logistics request and providing the extracted information to an automated quoting validator. The method may further include automatically generating at least one quote for the request at the automated quoting validator based upon, at least in part, one or more user defined parameters.

One or more of the following features may be included. In some embodiments, the method may include displaying the at least one quote at a graphical user interface. The automated quoting validator may be configured to automatically generate at least one quote based upon, at least in part, natural language processing. The automated quoting validator may automatically generate at least one quote based upon, at least in part, optical character recognition or robotic process automation. The automated quoting validator may be configured to automatically generate at least one quote at one or more predefined intervals. The logistics request receiver may be selected from the group consisting of an email, a website, or one or more electronic documents. The method may include automatically providing the at least one quote back to the logistics request receiver. The method may include storing the at least one quote at a database. The method may include displaying, using the automated quoting validator, the logistics request and the extracted information simultaneously at a graphical user interface. Displaying may include displaying a plurality of rate related information for each logistics request.

In one or more embodiments of the present disclosure, a system for automatically obtaining and processing logistics requests is provided. The system may include a computing device having at least one processor configured to automatically identify a logistics request from a logistics request receiver. In response to automatically identifying, the at least one processor may be configured to extract information from the logistics request, wherein the at least one processor may be configured to provide the extracted information to an automated quoting validator. The at least one processor may be configured to automatically generate at least one quote for the request at the automated quoting validator based upon, at least in part, one or more user defined parameters.

One or more of the following features may be included. In some embodiments, the at least one processor may be further configured to display the at least one quote at a graphical user interface. The automated quoting validator may be configured to automatically generate at least one quote based upon, at least in part, natural language processing. The automated quoting validator may automatically generate at least one quote based upon, at least in part, optical character recognition or robotic process automation. The automated quoting validator may be configured to automatically generate at least one quote at one or more predefined intervals. The logistics request receiver may be selected from the group consisting of an email, a website, or one or more electronic documents. The at least one processor may be configured to automatically provide the at least one quote back to the logistics request receiver. The at least one processor may be configured to allow for storing the at least one quote at a database. The at least one processor may be further configured to allow for the display, using the automated quoting validator, of the logistics request and the extracted information simultaneously at a graphical user interface. Displaying may include displaying a plurality of rate related information for each logistics request.

Additional features and advantages of embodiments of the present disclosure will be set forth in the description which follows, and in part will be apparent from the description, or may be learned by practice of embodiments of the present disclosure. The objectives and other advantages of the embodiments of the present disclosure may be realized and attained by the structure particularly pointed out in the written description and claims hereof as well as the appended drawings.

It is to be understood that both the foregoing general description and the following detailed description are exemplary and explanatory and are intended to provide further explanation of embodiments of the invention as claimed.

### BRIEF DESCRIPTION OF THE DRAWINGS

The accompanying drawings, which are included to provide a further understanding of embodiments of the present disclosure and are incorporated in and constitute a part of this specification, illustrate embodiments of the present disclosure and together with the description serve to explain the principles of embodiments of the present disclosure.

FIG. 1 is a diagram depicting an embodiment of a system in accordance with the present disclosure;

FIG. 2 is a flowchart depicting operations consistent with an embodiment of the present disclosure;

FIG. 3-18 show graphical user interfaces consistent with an embodiment in accordance with the present disclosure; and

FIG. 19 shows a graphical user interface depicting an example analytics display.

### DETAILED DESCRIPTION

Reference will now be made in detail to the embodiments of the present disclosure, examples of which are illustrated in the accompanying drawings. The present disclosure may, however, be embodied in many different forms and should not be construed as being limited to the embodiments set forth herein. Rather, these embodiments are provided so that this disclosure will be thorough and complete, and will fully convey the concept of the disclosure to those skilled in the art.

As will be appreciated by one skilled in the art, the present disclosure may be embodied as a method, system, or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

As used in any embodiment described herein, “circuitry” may include, for example, singly or in any combination, hardwired circuitry, programmable circuitry, state machine circuitry, and/or firmware that stores instructions executed by programmable circuitry. It should be understood at the outset that any of the operations and/or operative components described in any embodiment herein may be implemented in software, firmware, hardwired circuitry and/or any combination thereof.

Any suitable computer usable or computer readable medium may be utilized. The computer readable medium may be a computer readable signal medium or a computer readable storage medium. A computer-usable, or computer-readable, storage medium (including a storage device associated with a computing device or client electronic device) may be, for example, but not limited to, an electronic, magnetic, optical, electromagnetic, infrared, or semiconductor system, apparatus, or device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device. In the context of this document, a computer-usable, or computer-readable, storage medium may be any tangible medium that can contain, or store a program for use by or in connection with the instruction execution system, apparatus, or device.

A computer readable signal medium may include a propagated data signal with computer readable program coded embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations of the present invention may be written in an object oriented programming language such as Java, Smalltalk, C⁺⁺ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present disclosure is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

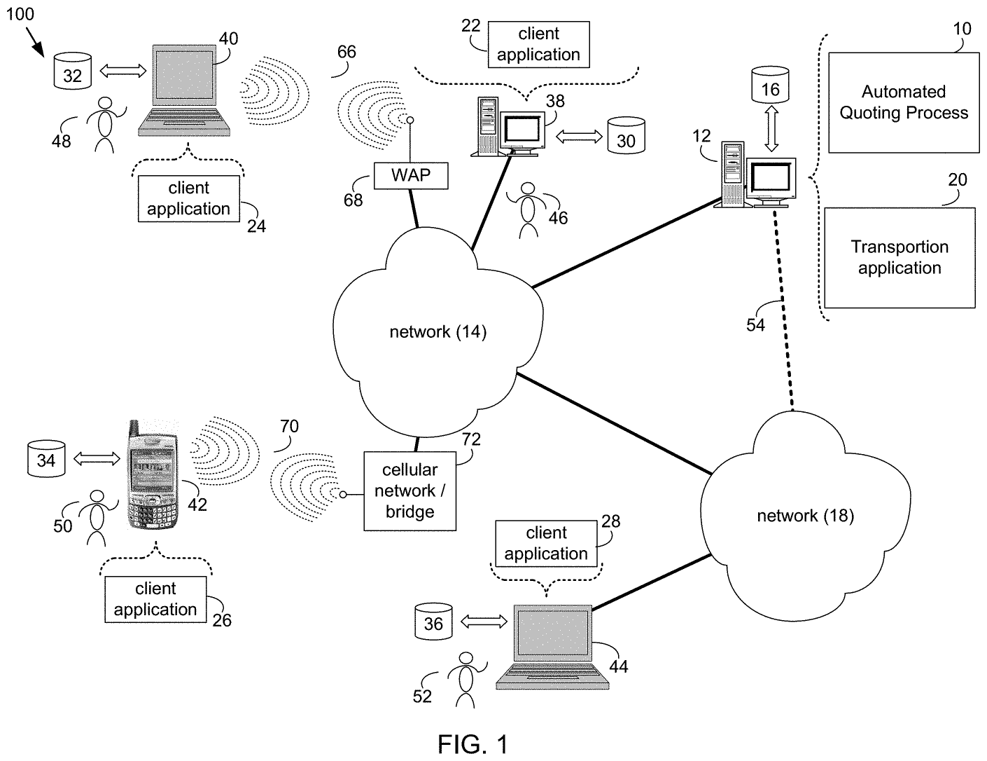

Referring to FIG. 1, there is shown an automated quoting process 10 that may reside on and may be executed by server computer 12, which may be connected to network 14 (e.g., the Internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft® Windows® Server; Novell® NetWare®; or Red Hat® Linux®, for example. (Microsoft and Windows are registered trademarks of Microsoft Corporation in the United States, other countries or both; Novell and NetWare are registered trademarks of Novell Corporation in the United States, other countries or both; Red Hat is a registered trademark of Red Hat Corporation in the United States, other countries or both; and Linux is a registered trademark of Linus Torvalds in the United States, other countries or both.) Additionally/alternatively, automated quoting process 10 may reside on and be executed, in whole or in part, by a client electronic device, such as a personal computer, notebook computer, personal digital assistant, or the like.

The instruction sets and subroutines of automated quoting process 10, which may include one or more software modules, and which may be stored on storage device 16 coupled to server computer 12, may be executed by one or more processors (not shown) and one or more memory modules (not shown) incorporated into server computer 12. Storage device 16 may include but is not limited to: a hard disk drive; a solid state drive, a tape drive; an optical drive; a RAID array; a random access memory (RAM); and a read-only memory (ROM). Storage device 16 may include various types of files and file types.

Server computer 12 may execute a web server application, examples of which may include but are not limited to: Microsoft IIS, Novell Webserve™, or Apache® Webserver, that allows for HTTP (i.e., HyperText Transfer Protocol) access to server computer 12 via network 14 (Web server is a trademark of Novell Corporation in the United States, other countries, or both; and Apache is a registered trademark of Apache Software Foundation in the United States, other countries, or both). Network 14 may be connected to one or more secondary networks (e.g., network 18), examples of which may include but are not limited to: a local area network; a wide area network; or an intranet, for example.

Server computer 12 may execute one or more transportation related applications (e.g., transportation application 20), examples of which may include, but are not limited to those available from the assignee of the present application. Transportation application 20 may interact with one or more client applications (e.g., client applications 22, 24, 26, 28).

Automated quoting process 10 may be a stand-alone application, or may be an applet/application/script that may interact with and/or be executed within transportation application 20. In addition/as an alternative to being a server-side process, automated quoting process 10 may be a client-side process (not shown) that may reside on a client electronic device (described below) and may interact with n transportation client application (e.g., one or more of client applications 22, 24, 26, 28). Further, automated quoting process 10 may be a hybrid server-side/client-side process that may interact with Transportation application 20 and a client application (e.g., one or more of client applications 22, 24, 26, 28). As such, automated quoting process 10 may reside, in whole, or in part, on server computer 12 and/or one or more client electronic devices.

The instruction sets and subroutines of transportation application 20, which may be stored on storage device 16 coupled to server computer 12 may be executed by one or more processors (not shown) and one or more memory modules (not shown) incorporated into server computer 12.

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory modules (not shown) incorporated into client electronic devices 38, 40, 42, 44 (respectively). Storage devices 30, 32, 34, 36 may include but are not limited to: hard disk drives; solid state drives, tape drives; optical drives; RAID arrays; random access memories (RAM); read-only memories (ROM), compact flash (CF) storage devices, secure digital (SD) storage devices, and a memory stick storage devices. Examples of client electronic devices 38, 40, 42, 44 may include, but are not limited to, personal computer 38, laptop computer 40, mobile computing device 42 (such as a smart phone, netbook, or the like), notebook computer 44, for example. Using client applications 22, 24, 26, 28, users 46, 48, 50, 52 may access transportation application 20 and may allow users to e.g., utilize automated quoting process 10.

Users 46, 48, 50, 52 may access transportation application 20 directly through the device on which the client application (e.g., client applications 22, 24, 26, 28) is executed, namely client electronic devices 38, 40, 42, 44, for example. Users 46, 48, 50, 52 may access application 20 directly through network 14 or through secondary network 18. Further, server computer 12 (i.e., the computer that executes application 20) may be connected to network 14 through secondary network 18, as illustrated with phantom link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 66 established between laptop computer 40 and wireless access point (i.e., WAP) 68, which is shown directly coupled to network 14. WAP 68 may be, for example, an IEEE 802.11a, 802.11b, 802.11g, Wi-Fi, and/or Bluetooth device that is capable of establishing wireless communication channel 66 between laptop computer 40 and WAP 68. Mobile computing device 42 is shown wirelessly coupled to network 14 via wireless communication channel 70 established between mobile computing device 42 and cellular network/bridge 72, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft Windows, Microsoft Windows CE®, Red Hat Linux, or other suitable operating system. (Windows CE is a registered trademark of Microsoft Corporation in the United States, other countries, or both.).

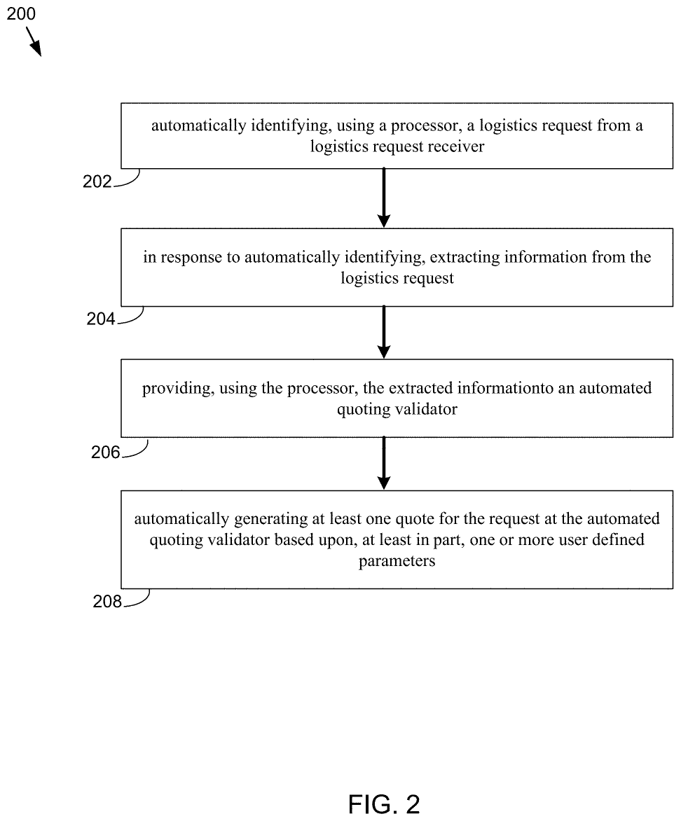

Referring now to FIG. 2, an exemplary flowchart 200 depicting operations consistent with automated quoting process 10 is provided. Embodiments may include automatically identifying, using a processor, a logistics request from a logistics request receiver. In response to automatically identifying, the method may also include extracting information from the logistics request and providing the extracted information to an automated quoting validator. The method may further include automatically generating at least one quote for the request at the automated quoting validator based upon, at least in part, one or more user defined parameters. Numerous other operations are also within the scope of the present disclosure.

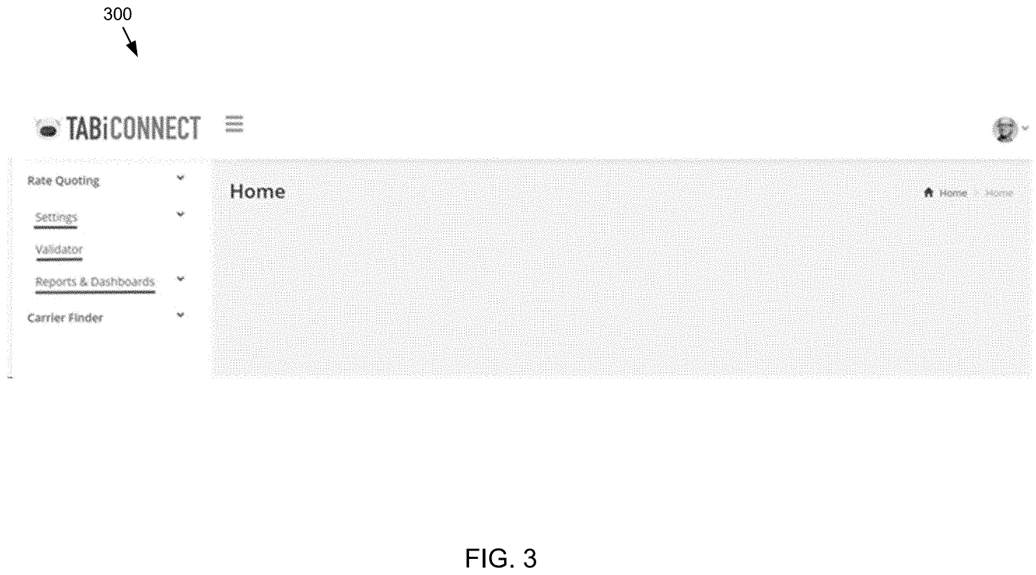

Referring now to FIGS. 3-19, various graphical user interfaces consistent with embodiments of automated quoting process 10 are provided. As shown in the Figures, embodiments of automated quoting process 10 provide a platform that may be configured to automate a variety of processes involved in the logistics and transportation industry. These processes may include, but are not limited to, Rate Quoting, Order Entry, and Carrier Sourcing.

In some embodiments, automated quoting process 10 may utilize application programming interface (“API”) integration or front-end access and may allow users to integrate their TMS (Transportation Management Systems) with various platforms. Some of these may include, but are not limited to, load boards, bid boards, cubing tools, capacity portals, tracking, financial and/or freight forecasting platforms to holistically automate every process.

In some embodiments, automated quoting process 10 may include a rate quoting module that may be configured to enable freight brokers to configure their business rules and quoting preferences into parameters. Accordingly, automated quoting process 10 may utilize various technologies, some of which may include, but are not limited to, optical character recognition (“OCR”), artificial intelligence, such as robotic process automation (“RPA”), and natural language processing (“NLP”). In this way, automated quoting process 10 may utilize one or more bots in order to process rate quoting requests received from different logistics request receivers (e.g., email requests, web portals, PDFs, etc.) to compute final rates based on the broker's parameters.

In some embodiments, automated quoting process 10 may utilize RPA. RPA may include one or more “bots” or “virtual assistants.” Bots may be developed in a “command center” or “control panel.” Bots may be a form of software code and, in some embodiments, may be configured to automate a task or process in a repetitive “rule-based” way. Bots may be configured to follow a predefined workflow of multiple steps and may interact with different software applications. In other embodiments, bots are configured to mimic the human interaction with a computer and may be configured to perform one or more of: a keystroke input, a point, and a click on the screen. With these interactions, the bot may be configured to perform the same tasks a human performs in a computer, however at a faster rate and with no errors.

In some embodiments, automated quoting process 10 may include RPA created from conventional software code by utilizing common programming languages. Examples of common programing languages may include, for example but are not limited to, JAVA, C++, JAVASCRIPT. In other embodiments, automated quoting process 10 may incorporate pre-built RPA tools that facilitate the development of the code, for example Automation Anywhere.

In some embodiments, automated quoting process 10 may be configured to help third-party brokers to increase their overall performance in the rate quoting process by reducing their response time, increasing accuracy in their quotes, optimizing margins and profits, and increasing the amount of quotes processed as well as the amount of quotes won.

In some embodiments, automated quoting process 10 may integrate different types of platforms to provide an end-to-end solution. There are different instances in automated quoting process 10, as the first step, it may be necessary to extract the information from every incoming logistics request. In this phase, there may be different ways to trigger automated quoting process 10.

In some embodiments, using NLP, automated quoting process 10 may be configured to read raw text from the body of every incoming email and extract the required information (“entities”) to process every request, on the other hand, if a request is received in a PDF, automated quoting process 10 may also read and extract all entities, but using OCR.

In an example embodiment, automated quoting process 10 may begin with an email request sent to an email address and/or email box. Automated quoting process 10 may connect to the desired inbox through an existing API. In some embodiments, automated quoting process 10 may log in to the email provider through the user interface utilizing RPA. RPA may include software coded to perform the log in task. The email may be categorized by an API utilizing NLP configured to determine if the email contains a quote request or not. NLP may include machine learning. In some embodiments, the email may be categorized utilizing an artificial intelligence model.

If the email is determined by automated quoting process 10 to contain a quote request, then the body of the email may be passed through one or more APIs. The one or more APIs may utilize one or more of NLP and Named Entity Recognition (“NER” also known as Named Entity Extraction) to analyze the text of the email.

In embodiments utilizing a text analysis technique (for example, NLP), automated quoting process 10 may identify specific words. Specifics words may also include words within phrases and may represent specific nouns. Automated quoting process 10 may parse a plurality of categories relevant to quoting process within the email with high accuracy. In some embodiments, 20 or more categories relevant to the quoting process may be identified and the required information may be extracted. Categories relevant to the quoting process may include, but are not limited to, one or more of: Pick Up Location (e.g. city, state and zip), Delivery Location, Commodity, Weight, and/or Dimensions.

In some embodiments, automated quoting process 10 may be configured to understand corrections. By understanding corrections, automated quoting process 10 may become more confident over time (i.e. accurate) when identifying emails that are a quote request, identifying text and/or extracting entities. After extracting text, some embodiments may display the results on screen. The displayed results may be validated and entities corrected that were extracted incorrectly or unsuccessfully. The results may be validated by a human. Once automated quoting process 10 receives any corrected entity extraction results, the model may be automatically updated to understand where automated quoting process 10 failed. In some embodiments, receiving any corrected entity extraction result and updating the entity may create a feedback loop to become more confident over time.

Additionally and/or alternatively, automated quoting process 10 may be configured to receive logistics requests from various logistics request receivers which may include, but are not limited to, websites or platforms where process 10 may use artificial intelligence, such as RPA, to extract information and process it. With these types of sources of information, automated quoting process 10 may be triggered at predefined times (e.g., every hour or every day at 8 AM, 10 AM, 2 PM, 4 PM, etc.).

In some embodiments, automated quoting process 10 may extract information from a web portal and/or a bid board. For example, rate requestors may populate the “lists” of available loads or Freight Requests in a shipper portal and/or ERP. Automated quoting process 10 may extract these lists, for example, utilizing RPA. RPA may be configured to input the requests into automated quoting process 10. With the input requests received, automated quoting process 10 may further process quotes based off scored parameters such as, for example, the company's quoting algorithm, and/or quoting logic parameters.

In some embodiments, automated quoting process 10 may also be configured to allow a user to compare and/or validate information using one or more graphical user interfaces. In this scenario, once the information is extracted and validated, automated quoting process 10 may then access one or more rate engines, obtain these rates, and calculate a final rate. In some embodiments, this final rate may be based upon, at least in part, some or all of the parameters previously configured by individual freight brokers. For example, some of these may include, method of calculation (e.g., lower, average, or higher), rates engines index, margins per distance tier, minimum rate per distance tier, accessorials, additional charges, etc. Finally, automated quoting process 10 may then publish these final rates in a graphical user interface.

In some embodiments, automated quoting process 10 may connect to a market rating portal and/or a rate engine, through API and/or RPA. The market rating portal and/or rate engine may be located in an externally managed system, such as, for example a customer's system. API may be a backend integrations between systems that may be configured to allow both systems to talk and exchange information that is queried at a given time. In other embodiments, RPA may be used in place of a back end API connection. Automated quoting process 10 may extract market price information. In some embodiments, automated quoting process 10 may utilize the market place information in the computation based on specified parameters to offer a complete rate. The complete rate may include, for example, but not limited to, a mark-up to the final customer. In some embodiments the specified parameters may be a broker's parameters.

Different broker's may have different specified parameters so automated quoting process 10 may allow for customization of the specified parameters. Broker's may have different parameters and/or different mark ups. These parameters and/or mark ups may depend on one or more of: the type of customer, market conditions, seasonality, times of the day, lanes, time of the week. In some embodiments, automated quoting process 10 may allow creation of quote profiles that may be based on the customer. In other embodiments, the quote profiles may be based on market conditions that are dynamic and are changing over time. Quote profiles may allow for a user to make a change once, and automated quoting process 10 may calculate all quotes based on the parameters changed at that point forward.

In some embodiments, automated quoting process 10 may be configured to connect and reply to every request in the same way as it was received. For example, if the logistics request receiver was an email, automated quoting process 10 may reply to that email with the final rate. Additionally and/or alternatively, if the logistics request receiver was a portal, automated quoting process 10 may go access the portal and publish the final rate.

In some embodiments, automated quoting process 10 may operate in conjunction with various types of platforms. Some of these may include, but are not limited to, transportation management systems (“TMS”), load boards, bid boards, cubing tools, capacity portals, tracking, financial or freight forecasting platforms. Automated quoting process 10 may access all these platforms using API integration, front-end access, or any other suitable approach.

In some embodiments, and referring now to FIG. 3, an introductory graphical user interface 300 showing embodiments of automated quoting process 10 is provided. In some embodiments, automated quoting process 10 may include a rate quoting module that includes settings, validator, and various reports and dashboards. Each of these is discussed in further detail hereinbelow.

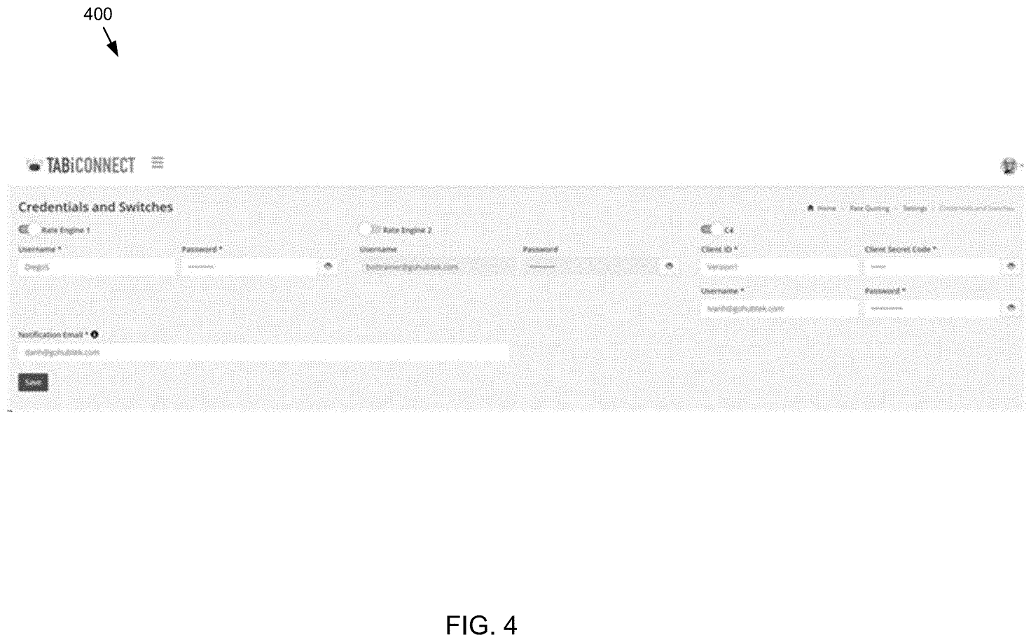

In some embodiments and referring now to FIG. 4, a graphical user interface 400 showing the settings option is provided. The settings menu may include a number of sub-menus such as the credentials and switches option shown in FIG. 4. In this page, users may configure all credentials they use in a daily basis to access external platforms, like Rate Engines, Capacity Portals, Forecasting Platforms, etc. Using this option a user may also enter one or more email addresses where automated quoting process 10 may be configured to send various notifications, for example, exceptions, confirmations, etc. In some embodiments, automated quoting process 10 may utilize artificial intelligence capabilities (e.g., RPA, etc.) and the information entered in this section may be captured to emulate the user's log in the different platforms in order to complete all steps required to pull rates from different engines.

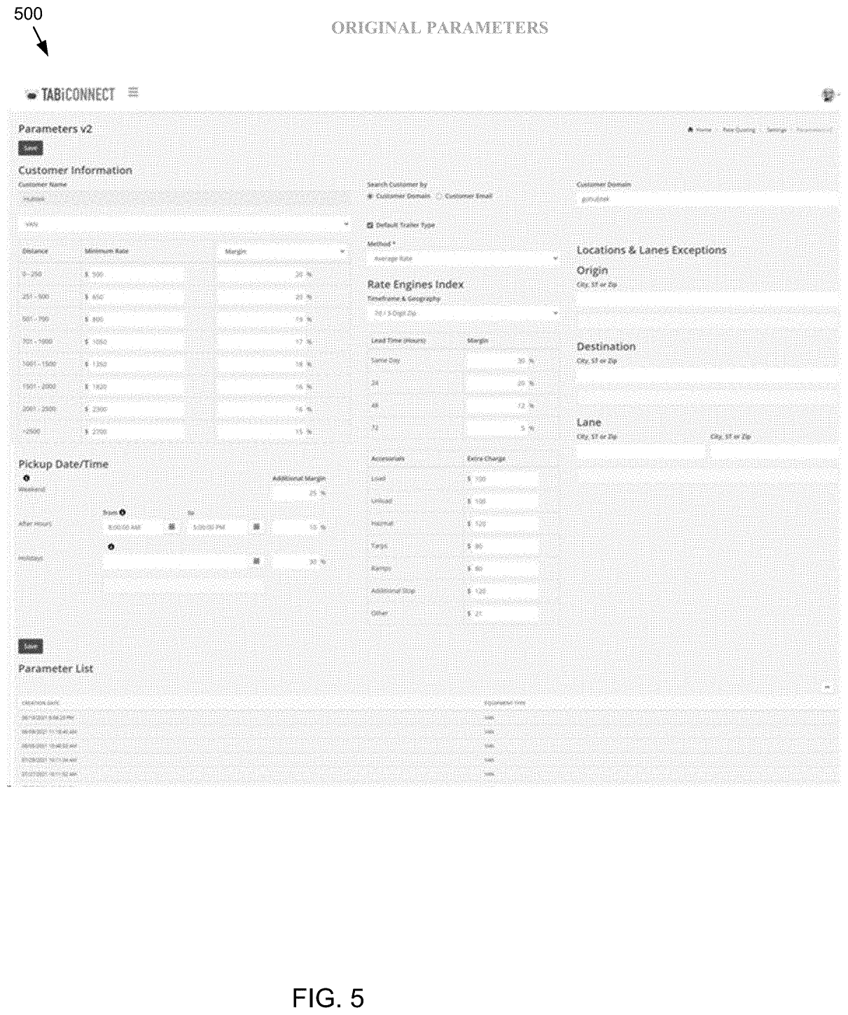

In some embodiments and referring now to FIG. 5, a graphical user interface 500 showing an initial parameters option consistent with embodiments of automated quoting process 10 is provided. In operation, one or more freight brokers can configure their business rules and preferences to provide automated rate quotes for their different customers. In this particular example, third party logistics have the possibility to customize multiple profiles considering the type of relationship they have with their customers. For example, the best customers may receive discounted rates based on their configured parameters. For this module, there may be a plurality of equipment types available. Some of these may include, but are not limited to, van, reefer, flatbed, specialized, where it may be necessary to configure a set of parameters per every equipment type. Some parameters may include, but are not limited to, distance tiers, minimum rate, and profit information. This parameter is used to enter the expected minimum rate and profit broken down by different distance tiers.

In some embodiments, and depending on the market conditions, freight brokers may determine the calculation method to be used when sending the final rate to their customers. For example, lowest, average, and/or highest cost per lane.

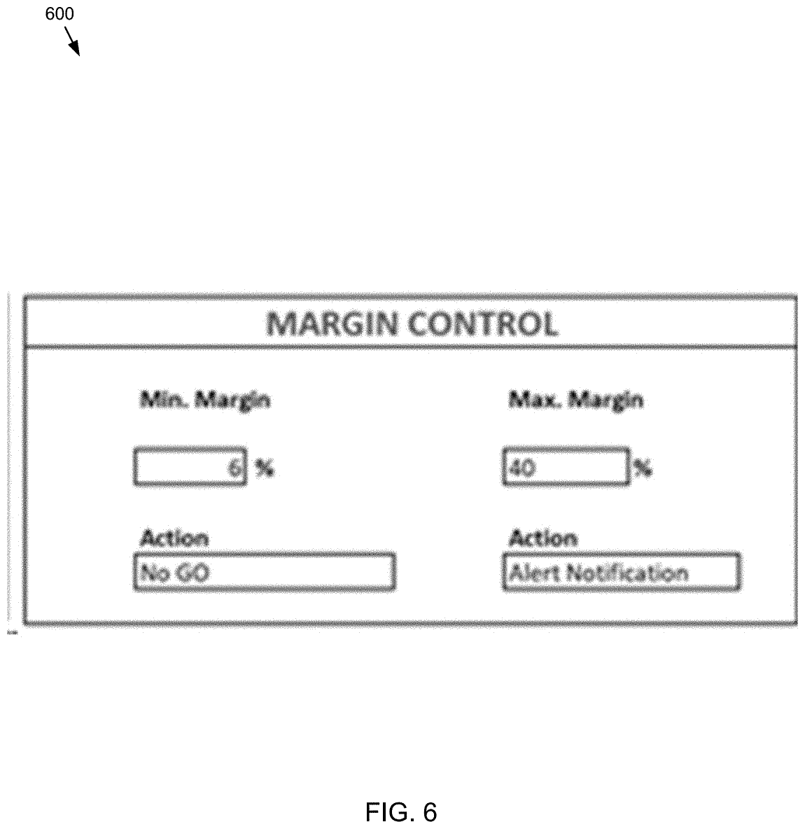

In some embodiments and referring now to FIGS. 6-11, various graphical user interfaces 600-1100 showing added parameters options consistent with embodiments of automated quoting process 10 are provided. FIG. 6 depicts a margin control graphical user interface 600. This provides an automated sanity check to confirm that all rates are sent with the desired margins. This parameter grants third party logistics control over their margins by defining a range and generating alerts when bots compute final rates with resulting margins out of this range. This parameter may also be used to automatically discard quotes requests where the resulting margin is out the predefined range.

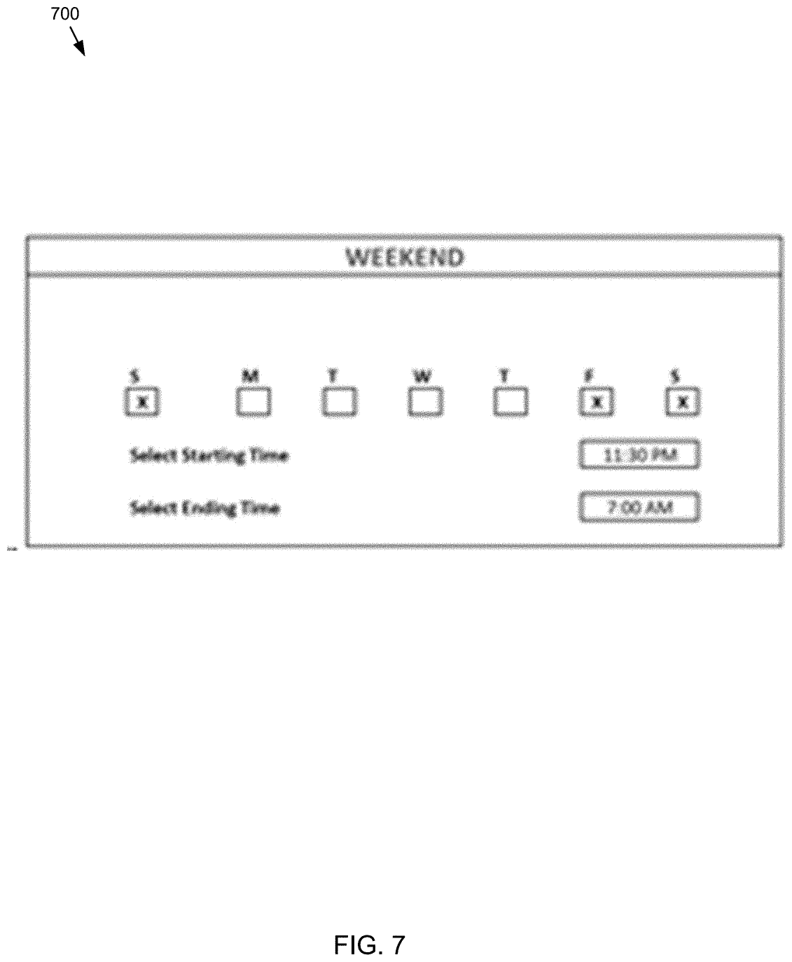

In some embodiments and referring now to FIG. 7 depicts a weekend graphical user interface 700 consistent with embodiments of automated quoting process 10. GUI 700 provides a dynamic parameter where freight brokers may configure what they consider weekend time and charge an additional fee for shipments that are required to be picked up during this predefined period of time. An afterhours option may also be provided. This may be similar to the weekend parameter and may allow users to configure their business hours and charge an additional fee for shipments that are required to be picked up out of this predefined period of time. Additionally and/or alternatively, a holidays option may be provided. This is a calendar function that may grant the possibility to charge an extra fee for picking up on any national holiday, other types of holidays, e.g., state or religious, and any other special dates when one or more freight broker considers that an additional fee must be charged.

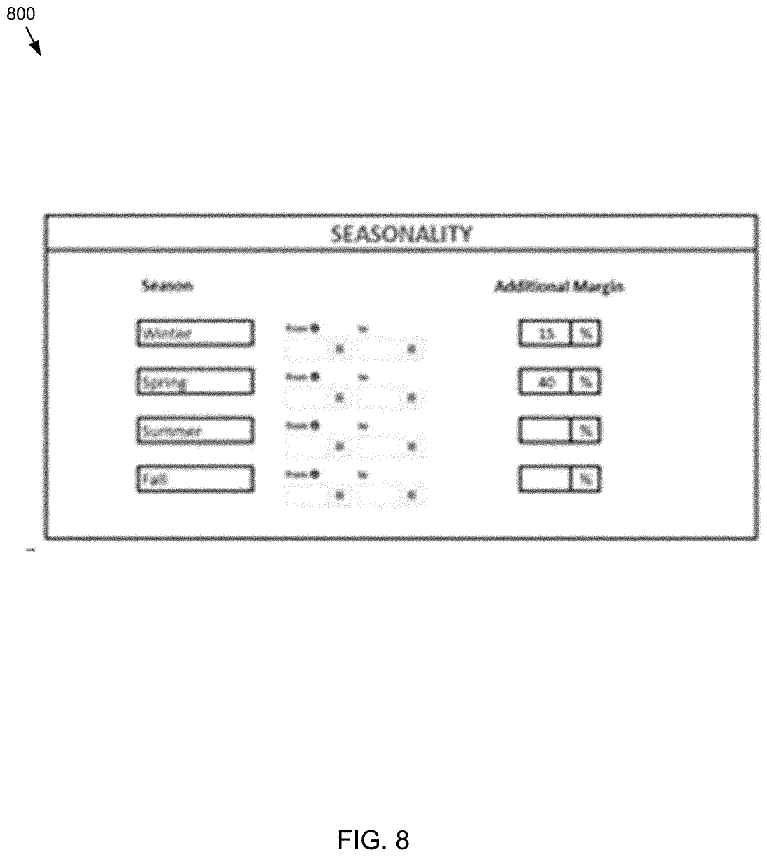

In some embodiments and referring now to FIG. 8, a seasonality graphical user interface 800 consistent with embodiments of automated quoting process 10 is provided. GUI 800 provides users with the ability to dynamically enter in the corresponding season the ‘From—To’ dates when they consider an amendment to the margins should be charged.

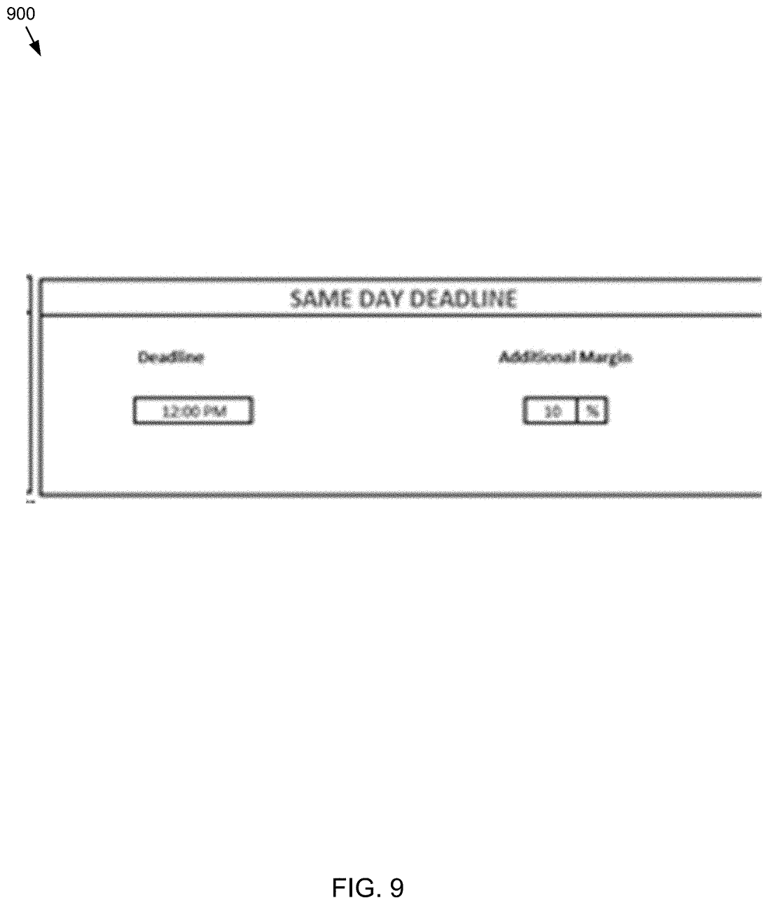

In some embodiments and referring now to FIG. 9, a same day deadline graphical user interface 900 consistent with embodiments of automated quoting process 10 is provided. GUI 900 provides a same day deadline option. With this parameter, freight brokers may set up a same day threshold where bots may capture an additional margin for same day shipments processed after that cut off.

In some embodiments, a lead time parameter may be included. Accordingly, for urgent pickups, third party logistics may configure associated additional margins to every time slot. For example, the sooner the shipment needs to be picked up the higher the additional margin. A rate engines index may also be included. This parameter may be used to instruct the bot how to use the different data points that engines offer to analyze market trends. For example, configure the desired timeframe and geography to extract the most accurate rate after running a search.

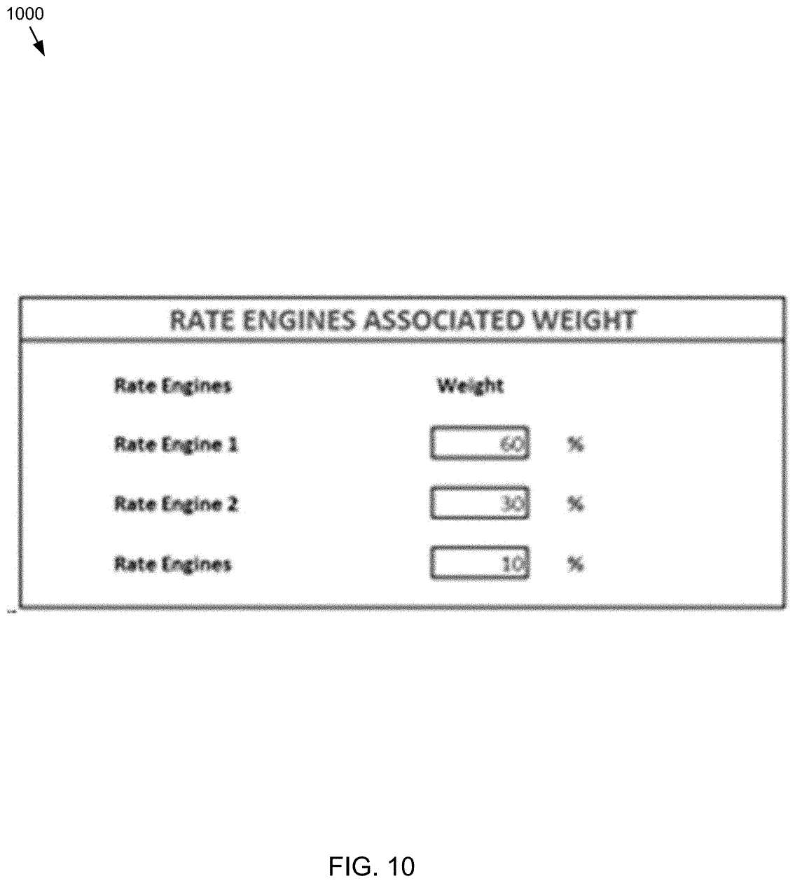

In some embodiments and referring now to FIG. 10, a rate engines associated weight graphical user interface 1000 consistent with embodiments of automated quoting process 10 is provided. GUI 1000 provides a parameter that may allow users to assign different weights to every rate engine based on the business preferences or engines performance, for example, preferred engines may weigh more.

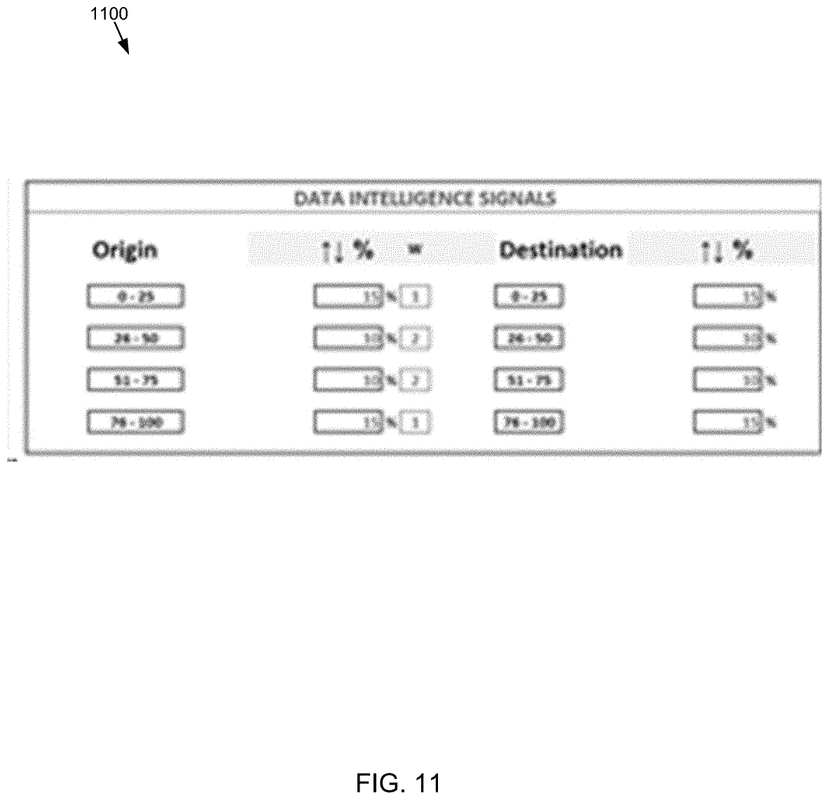

In some embodiments and referring now to FIG. 11, a data intelligence signals graphical user interface 1100 consistent with embodiments of automated quoting process 10 is provided. One or more bots associated with process 10 may be configured to read different signals or trends from data intelligence platforms. Examples of data intelligence platforms may include, but are not limited to, Cargo Chief C4®, Internet Truckstop, DAT, and/or Sonar. In some embodiments, the data intelligence platform may include the market information based on the history and/or previous loads stored in the customer's TMS. Accordingly, GUI 1100 provides a parameter that may grant users the possibility to follow these trends by setting up different ranges and thresholds to either decrease or increase the final rate based on the market conditions.

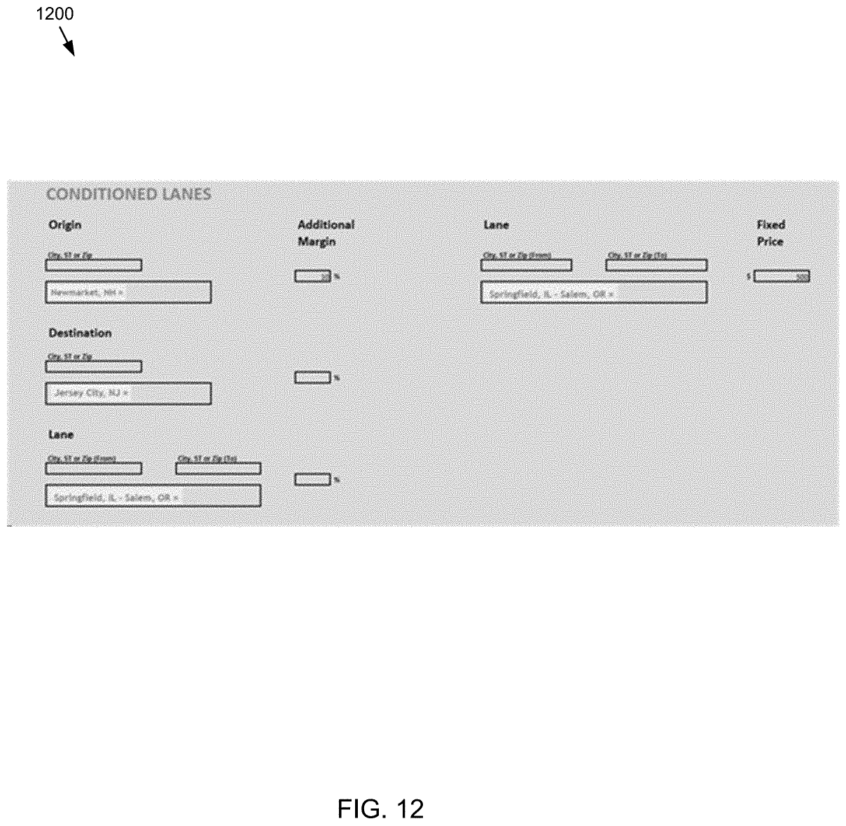

In some embodiments and referring now to FIG. 12, a conditioned lanes graphical user interface 1200 consistent with embodiments of automated quoting process 10 is provided. Restricted lanes refers to a parameter that may be used to ban any origin, destination or lane not desired by the third party logistics provider. The conditioned lanes parameter may be configured to allow users to configure an additional margin for any origin, destination, or lane, that the bot may use to compute the final rate. Another use for this parameter is to set up a fixed price for certain lanes.

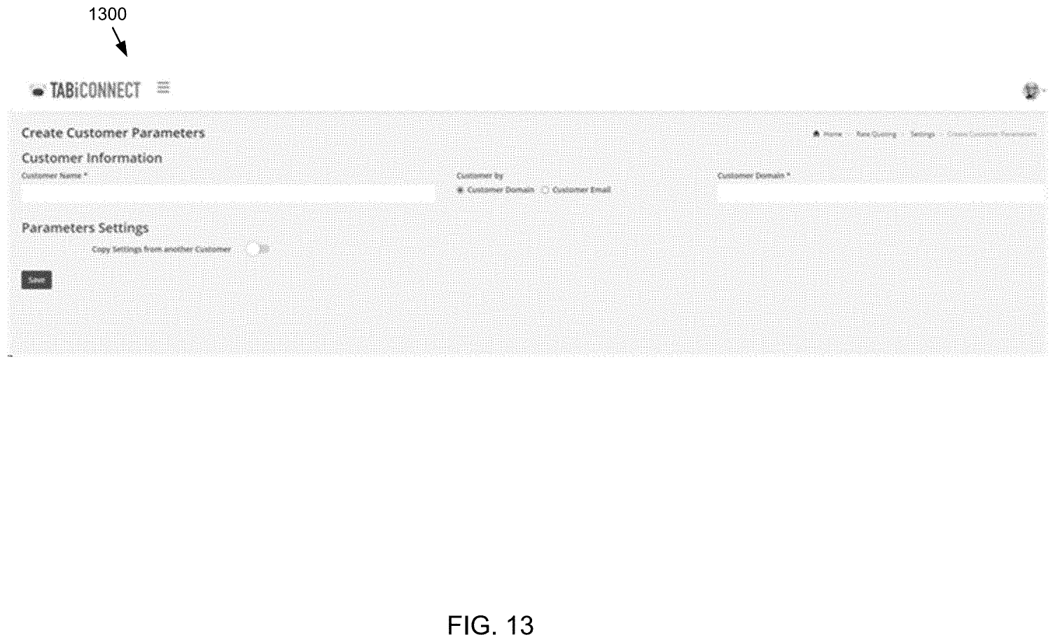

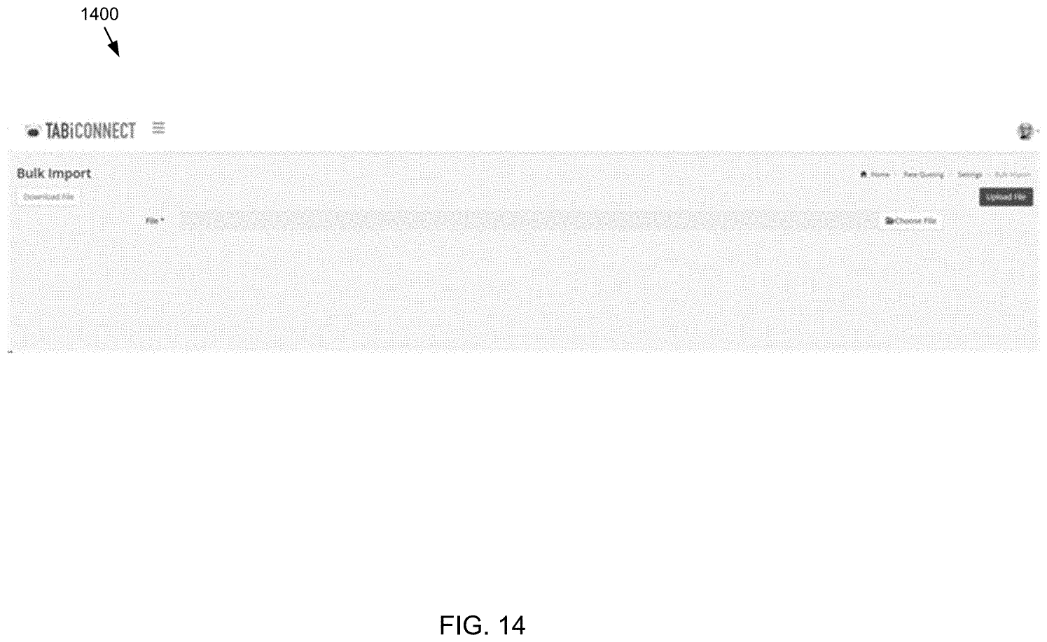

In some embodiments, and referring also to FIGS. 13-14, various customizable parameters and bulk import options may be available. In some embodiments, there may be an accessorial parameter that may be included. There may be any number of these associated to a shipment. In this way, freight brokers may define a fixed price to each accessorial that should be added to the final rate. There is an additional option “others” for accesorials not listed.

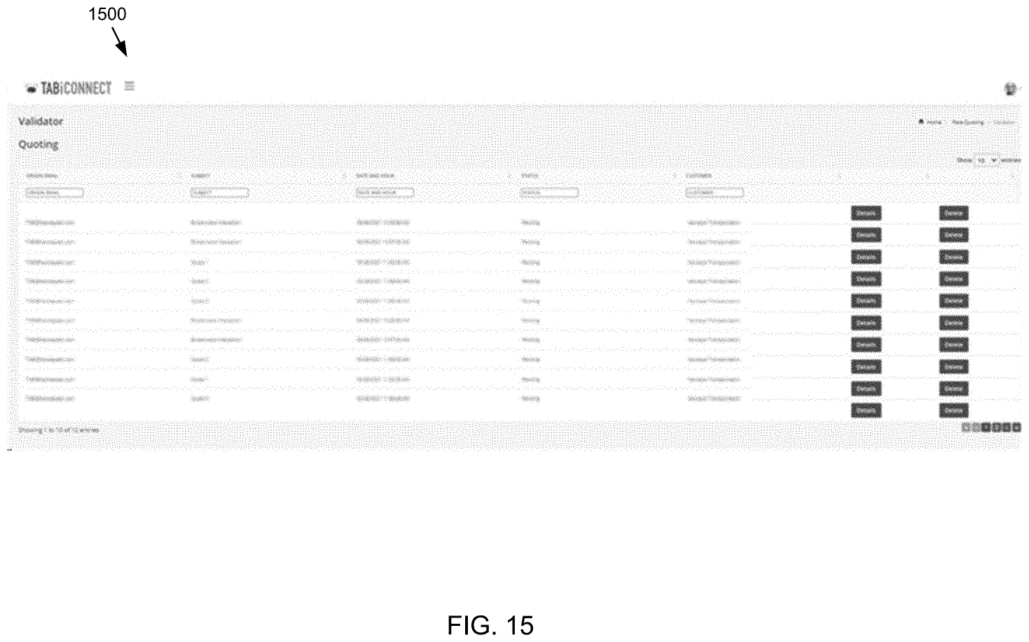

In some embodiments and referring now to FIG. 15, a validator graphical user interface 1500 consistent with embodiments of automated quoting process 10 is provided. GUI 1500 provides a quoting validator that may be configured to utilize natural language processing). Accordingly, automated quoting process 10 may employ bots that may publish here a list of one or more rate requests extracted from the body of a predefined email address. Through this view, users may access the details of every rate request by selecting the ‘Details’ option.

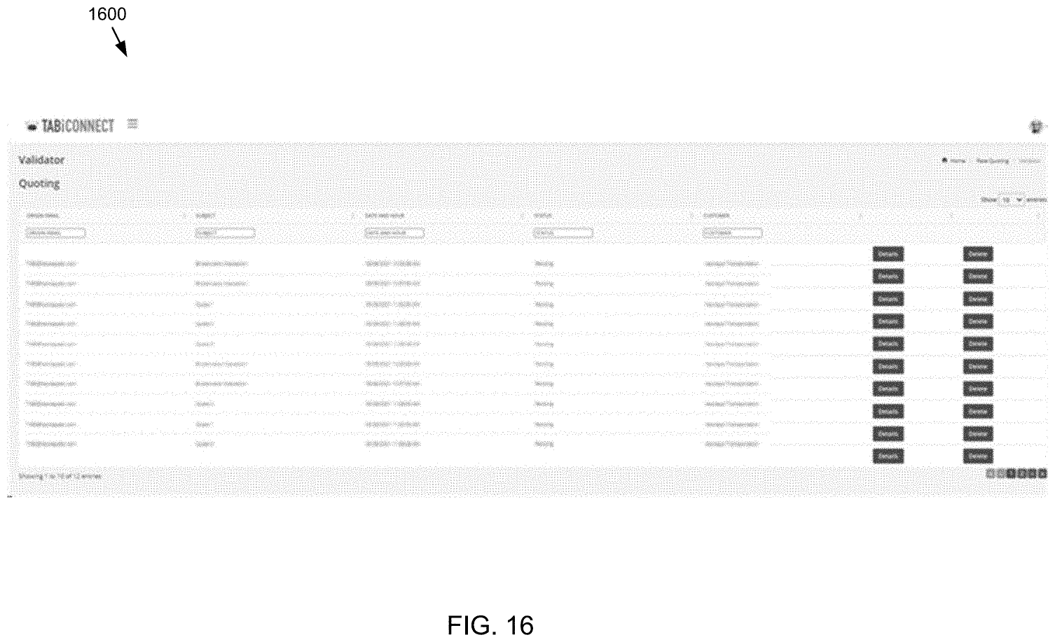

In some embodiments and referring now to FIG. 16, a details graphical user interface 1600 consistent with embodiments of automated quoting process 10 is provided. GUI 1600 provides a trip details view, which may be configured to display a copy of the original email in the right side of the page so users may compare it with the extracted information. On the left side of the page, users may double check that all information published is accurate, otherwise they may edit any field before clicking on ‘Quote Now’, which triggers automated quoting process 10 to complete each transaction with 100% accurate information (e.g. using the artificial intelligence approaches discussed herein). By validating every trip, these machine learning based approaches may allow for training the cognitive model to improve accuracy of future extractions.

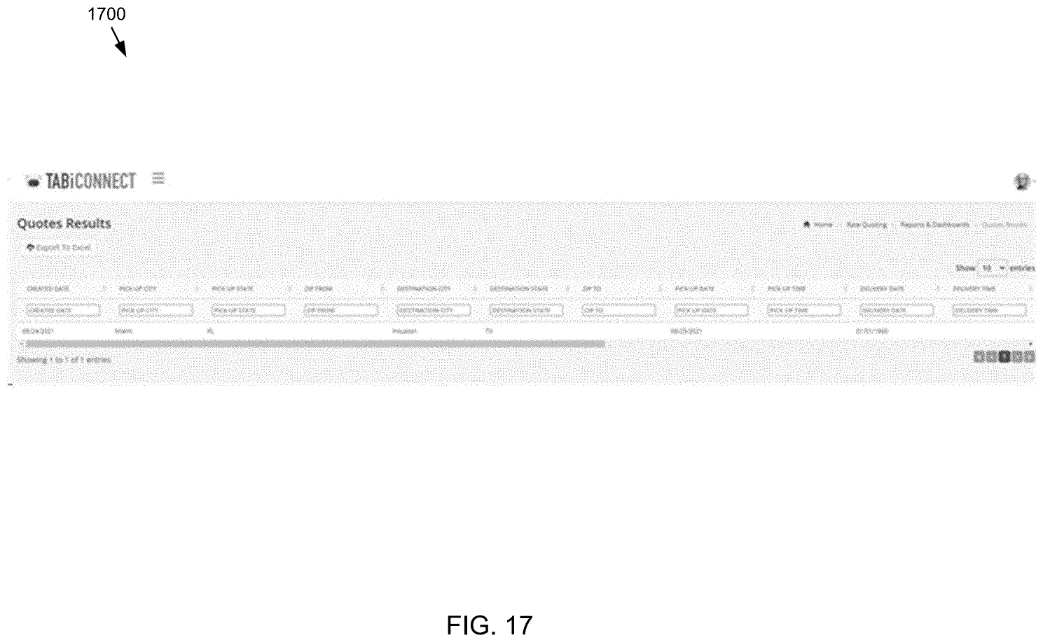

In some embodiments and referring now to FIG. 17, a reports and dashboards graphical user interface 1700 consistent with embodiments of automated quoting process 10 is provided. GUI 1700 provides a quotes results display. For every quote request, bots associated with automated quoting process 10 may publish here the results of every rate engine and compute a weighted average among the different results. This page may also show some or all information related to every rate request. Some of this information may include, but is not limited to, created date, origin, destination, pickup date/time, delivery date/time, accesorials, trailer type, miles, LoadID (if captured), etc.

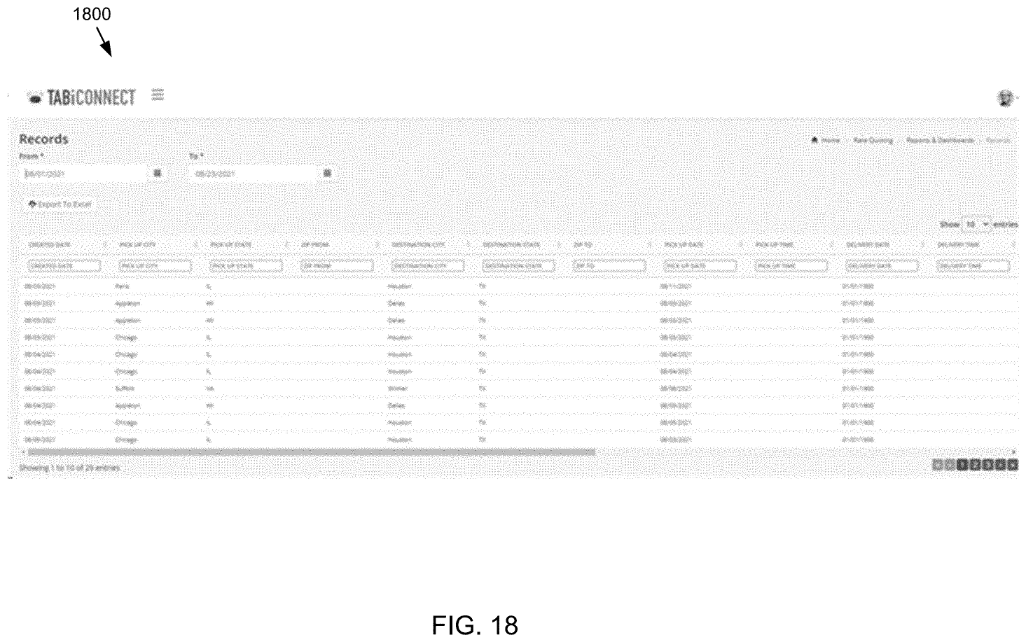

In some embodiments and referring now to FIG. 18, a records graphical user interface 1800 consistent with embodiments of automated quoting process 10 is provided. GUI 1800 provides a view where users may access all results within a selected period of time. For example, it may display some or all of the same information listed in the ‘Quotes Results’ page, but it may grant the possibility to select a range of days.

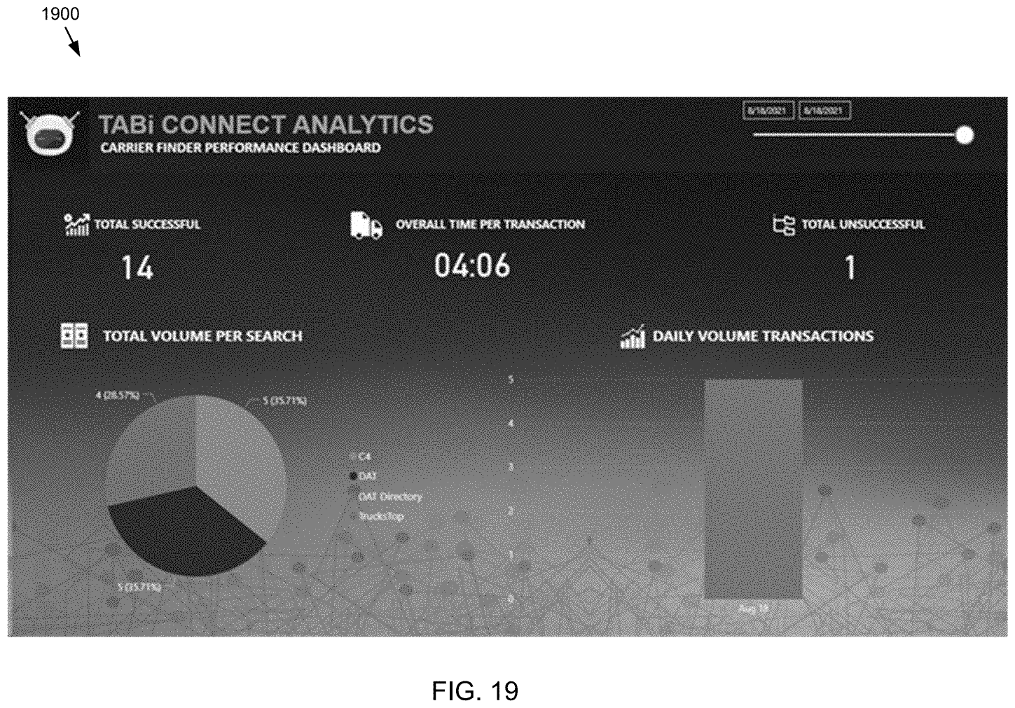

In some embodiments and referring now to FIG. 19, a dashboards graphical user interface 1900 consistent with embodiments of automated quoting process 10 is provided. GUI 1900 provides a display where all users can see how automated quoting process 10 is performing. Some of the key performance indicators (“KPIs”) may include, but are not limited to, amount of completed transactions in a period of time, amount of exceptions, average time per transaction, average time per rate engine, among others. Every dashboard may be customized based on the most relevant KPIs for every freight broker.

Embodiments of automated quoting process 10 provide numerous advantages over existing approaches. Some of these may include, but are not limited to, providing access through user level, which doesn't require API connections to interact with other platforms or websites, the user does not have to enter the load information or lane manually, the automation takes it from the request, parameters at tenderer email address level, customizable parameter lists, lane and location volume exception handling, not just all or nothing, preset calendar for additional margin, mileage tiered margin per customer per equipment type or per tenderer per equipment type, copy parameter sets from another built set to save time, saved parameter sets for ease of re-use, not a rate engine, performs the same process a human should do using rate sources, human intervention not required every task, process can be completed with no human interaction, provides the ability to turn on and off rate sources in real time, not preset and provider determines where rates come from or have to ask provider to make changes when needed, option of margin by % or $ amount, location exception by shipper or receiver, not just city, st, provides the ability to select rate index option, automation moves to next index if no results returned, hours of the day options at load pickup level or quote request level, connects the shipper rate request with carrier truck rates from any rate engine used by the third party logistics, doesn't require shipper input or carrier input into the system, audit option with the validator if the user wants a stop point or if information needs confirmed prior to submitting, etc.

Embodiments of automated quoting process 10 allow for automated rate quoting with no, or limited, human interaction. Important parameters have been added into the rate quote which is difficult to do when with human quoting. Process 10 provides for consistency of using parameters into rate quotes where humans typically leave factors out. Additionally and/or alternatively, the response time may be significantly reduced from manual rate quoting. Quotes are automatically recorded to have historical records, not relying on a human to complete the recording of the quote into their platform used. No missed rate quote opportunity that is common with humans not having the time to complete all requests. Accordingly, automated quoting process 10 is unique as it may process a rate request from the moment is received and reply with a final rate with limited human intervention, and it achieves this quicker and more accurately than prior approaches.

It will be apparent to those skilled in the art that various modifications and variations can be made in the embodiments of the present disclosure without departing from the spirit or scope of the present disclosure. Thus, it is intended that embodiments of the present disclosure cover the modifications and variations provided they come within the scope of the appended claims and their equivalents.

What is claimed is:

1. A computer-implemented method for automatically obtaining and processing logistics requests comprising:
automatically identifying, using a processor, a logistics request from a logistics request receiver;
in response to automatically identifying, extracting information from the logistics request;
providing, using the processor, the extracted information to an automated quoting validator; and
automatically generating at least one quote for the request at the automated quoting validator based upon, at least in part, one or more user defined parameters.

2. The computer-implemented method of claim 1, further comprising:
displaying the at least one quote at a graphical user interface.

3. The computer-implemented method of claim 1, wherein the automated quoting validator automatically generates at least one quote based upon, at least in part, natural language processing.

4. The computer-implemented method of claim 1, wherein the automated quoting validator automatically generates at least one quote based upon, at least in part, optical character recognition or artificial intelligence.

5. The computer-implemented method of claim 1, wherein the automated quoting validator automatically generates at least one quote at one or more predefined intervals.

6. The computer-implemented method of claim 1, wherein the logistics request receiver is selected from the group consisting of an email, a website, or one or more electronic documents.

7. The computer-implemented method of claim 6, further comprising:
automatically providing the at least one quote back to the logistics request receiver.

8. The computer-implemented method of claim 1, further comprising:
storing the at least one quote at a database.

9. The computer-implemented method of claim 5, further comprising:
displaying, using the automated quoting validator, the logistics request and the extracted information simultaneously at a graphical user interface.

10. The computer-implemented method of claim 2, wherein displaying includes a plurality of rate related information for each logistics request.

11. A system for automatically obtaining and processing logistics requests comprising:
a computing device having at least one processor configured to automatically identify a logistics request from a logistics request receiver, wherein in response to automatically identifying, the at least one processor is configured to extract information from the logistics request, wherein the at least one processor is configured to provide the extracted information to an automated quoting validator, wherein the at least one processor is configured to automatically generate at least one quote for the request at the automated quoting validator based upon, at least in part, one or more user defined parameters.

12. The system of claim 11, further comprising:
displaying the at least one quote at a graphical user interface.

13. The system of claim 11, wherein the automated quoting validator automatically generates at least one quote based upon, at least in part, natural language processing.

14. The system of claim 11, wherein the automated quoting validator automatically generates at least one quote based upon, at least in part, optical character recognition or artificial intelligence.

15. The system of claim 11, wherein the automated quoting validator automatically generates at least one quote at one or more predefined intervals.

16. The system of claim 11, wherein the logistics request receiver is selected from the group consisting of an email, a website, or one or more electronic documents.

17. The system of claim 16, further comprising:
automatically providing the at least one quote back to the logistics request receiver.

18. The system of claim 11, further comprising:
storing the at least one quote at a database.

19. The system of claim 15, further comprising:
displaying, using the automated quoting validator, the logistics request and the extracted information simultaneously at a graphical user interface.

20. The system of claim 12, wherein displaying includes a plurality of rate related information for each logistics request.
